(19) United States
(12) Patent Application Publication
(10) Pub. No.: US 2011/0243182 A1
(43) Pub. Date: Oct. 6, 2011

(54) INFRARED TEMPERATURE MEASURING DEVICE

(75) Inventors: Kerstin Tetzlaff, Freiburg (DE); Wolfgang Schwörer, Loffingen (DE); Frank Eder, Eggingen (DE)

(73) Assignee: TESTO AG, Lenzkirch (DE)

(21) Appl. No.: 12/673,667

(22) PCT Filed: Aug. 8, 2008
(86) PCT No.: PCT/EP08/06556

§ 371 Date: Aug. 2, 2010

(30) Foreign Application Priority Data
Aug. 14, 2007 (DE) 10 2007 038 272.5
Sep. 7, 2007 (DE) 10 2007 042 750.8

(51) Int. Cl. G01J 5/00

(52) U.S. Cl. 374/131

(57) ABSTRACT

A measuring device (1) for contactlessly measuring the temperature is provided with imaging optics (3, 3′) for IR radiation (5), which is incident on a measurement object (16) from a measuring spot (14), and a measuring spot marking apparatus (11) which generates a measuring spot mark (15) which delimits the measuring spot (14), wherein the aperture angle detected by the imaging optics (3, 3′), can be varied using an adjustment device (7), and the adjustment device (7) can be used to change the size of the measuring spot mark (15) in a manner corresponding to the variation in the aperture angle (FIG. 2).

The invention relates to a measuring device for contactless temperature measurement, in particular, a portable measuring device, with imaging optics for IR radiation and an IR radiation detector, wherein the imaging optics capture the IR radiation incident from a measuring spot on a measurement object and direct it onto the IR radiation detector, and with a measuring spot marking device with at least one sighting beam generator having a radiation source for visible light and at least one optical element, wherein the measuring spot marking device generates a measuring spot mark bordering the measuring spot on the measurement object.

Portable temperature measuring devices of the type mentioned above are known and are available in various designs, wherein, on its way from the measurement object to the sensor element, the radiation signal emitted by the measurement object follows a fixed beam path upon entry into the measuring device. This situation has the effect that changing the size of the measuring spot is quite complicated for the user of the measuring device. For the desired change in size, the distance of the measuring device itself from the measurement object must be iteratively varied until the desired size is reached. Under certain circumstances, the desired size of the measuring spot cannot be achieved at all, due to the frequently extreme environmental conditions because, in case of high temperatures of the measurement object and a large aperture ratio of the optical arrangement, the optical system's aperture ratio, which is coupled to the beam path, cannot be made to conform with the distance from the object necessary for the desired measuring spot size.

A device for temperature measurement is known from DE 195 28 590 A1, in which an optical system is formed by a dichroic beam splitter and an infrared lens, wherein the thermal radiation emitted from the measuring spot first reaches the beam splitter, which deflects the thermal radiation by 90° and guides it to an infrared lens, whereas the beam splitter is transmissive for the visible light of a sighting device. The sighting device produces a marking whose size depends on the measurement distance and the desired measurement precision.

A device and a method for infrared temperature measurement are known from DE 100 36 720 A1, in which a fixedly arranged annular optical system forms a marking beam path that surrounds the outer periphery of the measuring beam path, wherein the marking light is oriented in such a manner that, at every point of the marking beam path, its cross section perpendicular to the optical axis forms a circular ring surface.

A device for contactless temperature measurement is known from DE 103 43 258 A1 that comprises a sighting device for marking the position and/or the size of a measuring spot on a measurement object, wherein the sighting device has a light source for providing a least two sighting beams, and an independent light source is furnished for providing each sighting beam.

A laser system is known from EP 1 489 398 A1 that has at least three lasers, wherein one laser defines a central or nearly central, undivided spot, and the other two lasers define one or more spots, each arranged at or near the periphery of a visual field of the detector.

A sensor for infrared radiation from a human body is known from JP 57 019 626 A, in which a concave mirror is movable along an optical axis, wherein the concave mirror is arranged in such a manner that a sensor is arranged inside the focal distance of the mirror, and the human body is detected in a broad angle of view, and then the arrangement is adjusted in such a manner that the sensor is arranged in the focal point of the concave mirror and a small angle of view of the human body is acquired.

A temperature measurement device is known from DE 20 2004 007 142 U1 that has an adjustable mount for a plurality of different diaphragms and/or filters, by means of which mounts a plurality of diaphragms and/or filters can be positioned in the beam path of a detector, wherein the detector is constructed for detecting thermal radiation.

A virtual black body radiation system and a radiation temperature measurement system are known from U.S. Pat. No. 6,467,952 B2, in which an LED is operated with a defined current and the intensity of the light emitted by the LED can be adapted by an optical unit to the intensity of a specified black body radiation, whereby the virtual black body radiation system is capable of providing light of the desired intensity without changing the operating current of the LED.

A device for measuring the surface temperature of rotating objects is known from DE 91 00 941 U1, wherein a measuring device and a target laser device are integrated with one another in a common housing that supports an infrared measurement head on one side and is furnished with an opening for passage of the measuring beam path that determines the effective angle, wherein one reference element for a high or low temperature is arranged alongside each side of the opening, and reflecting means are provided in order to couple the laser pointer of the target laser into the measuring axis.

The problem is to provide a portable temperature measurement device that allows the user to vary the measuring spot size under difficult ambient conditions, without changing the position of the temperature measurement, and thus enables an easy and quickly performed temperature measurement.

This problem is solved in a measurement device of the above-mentioned type in that a first adjustment device with which the imaging scale of the imaging optics can be changed is connected to the imaging optics, in that the measuring spot marking device has a second adjustment device, with which the size of the measuring spot marker on the measurement object is variable, and in that the first adjustment device is connected to the second adjustment device in such a manner that the first adjustment device brings about a corresponding variation of the measuring spot marker by the second adjustment device.

Easy and fast temperature measurement with a substantially stationary temperature measurement device is thus made possible either in that the adjustment device according to the invention for the optical arrangement constituting the imaging optics changes the position of optical elements of the optical arrangement relative to one another, or the position of the optical arrangement relative to the sensor element, or in that the diameter of the light beam transmitted in the optical arrangement in the direction of the sensor element is changed by a different optical element, for example, a diaphragm. In particular, it is possible in this manner to achieve an infinitely variable adjustment of the measuring spot size from a nearby focal point into the far field of the optics in the measuring device.

An advantageous implementation of the temperature measurement device according to the invention with respect to easy manufacturing and good handling can consist of forming the optical elements of the optical arrangement from a number of lenses and/or mirrors that are movable relative to one another inside a housing.

A different embodiment of the portable temperature measurement device, in which one of the optical elements is provided as a diaphragm with an opening diameter discretely or continuously variable by the adjustment device, also offers good handling. This diaphragm can be constructed, for example, as an iris diaphragm with blades.

The adjustment device of the optical arrangement is expediently arranged on the temperature measuring device in such a manner that it restricts the usability of the latter as little as possible, even under cramped conditions, so that an advantageous refinement of the temperature measurement device can be to arrange the adjustment device parallel to the optical arrangement to be moved in the temperature measuring device. The adjustment device can also be housed at other suitable places, for example, inside a common housing with the optical arrangement.

In order to be able to guarantee a secure variation of position and/or situation by the adjustment device, the adjustment device for the imaging optics is expediently provided with at least one drive means that that can be driven manually, electrically, pneumatically or hydraulically.

Particularly if a linear motion is necessary for a position and/or situation change of movable parts in the optical arrangement, the drive means of the adjustment device can advantageously be provided with a coupling element, in particular, a spindle drive, engaged with at least one optical element.

Especially precise movements of the optical elements in the optical arrangement can be achieved with an embodiment in which the coupling element is manually operable by means of a setscrew, or by an electric motor, in particular, a stepper motor.

In another embodiment of the portable temperature measurement device, the adjustment device can be provided to move the optical elements of the optical arrangement into specified positions, or to continuously vary their position. In this case, a position specification for diaphragm settings and a continuous movement path for lenses can be expedient. Fixed movement positions for lenses and/or mirrors of the optical arrangement in the temperature measurement device are also conceivable, however; if desired, it is possible to provide different transmission ratios on the drive means for different movement positions because of the different movement paths for them.

In order to facilitate the orientation of the temperature measurement device onto a defined point or area of the measurement object for the user, the temperature measurement device according to the invention is provided with a projection means constituting a measuring spot marking device that projects the extent of the measuring spot to be detected onto the measurement object.

This projection means can be constructed, for example, as a laser sight that projects a cross-shaped or circular pattern with the extent of the measuring spot on the measurement object.

In an advantageous refinement of the measurement device, the projection means is formed for projection of the measuring spot dependent on the arrangement of the optical elements, whereby the size of the measuring spot can be adapted as a function of the optical elements positioned or modified by means of the adjustment device, so that an adjustment of the optical arrangement suitably adapted to the measuring spot size can be achieved with the measurement device.

Another embodiment of the temperature measurement device is expediently furnished with an add-on control means that automatically converts a change of position or aperture ratio of the optical elements into a control signal for the projection means or conversely converts a change in size of the projection on the projection means into a control signal for the optical elements of the optical arrangement. If the control means in question is turned off, the optical arrangement and the projection means can also be operated independently of one another. For this purpose, the projection means has or is coupled to a second adjustment device.

In a refinement of the portable temperature measurement device with possibly independent inventive significance, a sensor means is provided thereon that optically detects an area of the measurement object in the vicinity of the measuring spot, so that a planar image of the respective area on the measurement object can be produced and evaluated.

In order to determine the distance of the measuring spot on the measurement object from the temperature detection device as accurately as possible, a practical construction of the temperature measurement device can be furnished with a transmitter, particularly an ultrasound or infrared transmitter, that generates signals which can be evaluated by one of the sensor means.

The sensor means has good optical detection capabilities, as well as the possibility of being easily and securely arranged and housed, in an embodiment of the temperature measurement device in which the at least one sensor means is constructed as an image sensor, preferably a CCD sensor, and it can be specified on the measuring device whether one or more points, an area, or the entire sensor surface are participating in the generation of the measured value.

In order to obtain distance information from the optical information of the at least one sensor means, it is possible to provide on the temperature measurement device according to the invention an evaluation unit that evaluates measured values of the at least one sensor means with regard to a frequency distribution or a phase comparison.

To use the distance information obtained by means of the sensors and evaluated by the evaluation unit, it is possible to assign a control unit to the temperature measurement device, expediently to the evaluation unit, that is provided to convert measurement values of the sensor means into control signals for the adjustment device, in particular, for focusing.

The invention offers the additional advantage that the measuring spot marking device creates a measuring spot marker bounding the measuring spot. It can be provided in this regard that the sighting beam generator of the measuring spot marking device has at least one beam shaper that comprises at least one transmissive and/or refractive optical element.

In particular, an unambiguous marking of the measuring spot is achieved by the complete bounding of the measuring spot. If, for example, the measuring spot is a square, then the measuring spot marker also appears as a square. If the measurement object is gradated in depth, or if objects protrude into the measuring spot between the measurement device and the measurement object, then an unambiguous identification is possible with the measuring spot marker according to the invention, since a part of the measuring spot marker is imaged on the interfering object in this case. In other words, this means that a correct measurement is not possible if the complete measuring spot marker is not visible on the measurement object.

Thus, the completely bounded measuring spot marker serves not only for unambiguous representation of the measuring spot, but also allows a direct monitoring of the measuring spot and permits the user to make a target correction if desired.

The transmissive optical element preferably has a diffraction element, for example, a diffraction structure, in particular, a diffraction grating or a computer-generated hologram. It is possible to calculate diffraction structures in reverse using numerical methods, so that the necessary diffraction structure can be determined starting from a desired result. Therefore an appropriate measuring spot marker is possible for any conceivable shape of the measuring spot.

Alternatively, the transmissive optical element can also comprise a refractive element, such as a lens array or a lens with a continuous surface profile. Refractive optical elements can also be calculated in reverse, so that any desired structures can be imaged by them as well. It is also an advantage of refractive elements that the incident light enter nearly completely into the desired distribution, whereas a part of the light is lost with diffractive elements due to destructive interferences.

The measuring spot marking device preferably has N sighting beam generators, where N is a positive integer, and a measuring spot marker bounding the measuring spot is composed of N sighting beams. In principle, it is possible to shape a sighting beam as a circle or square, but it is difficult to direct this sighting beam onto the optical axis of the sensor, insofar as the sighting beam generator itself is not arranged on the optical axis. If it were, however, it would lie in the measuring area, so that it makes sense to use at least two sighting beam generators. In that way, it is easier to orient the individual sighting beam generators coaxially along the optical axis of the sensor. In addition, the brightness of the measuring spot marker increases with the number of sighting beam generators, so that a better visibility is possible even under difficult light conditions.

In practical terms, the measuring spot marker is formed by several sighting beams, which can overlap or be separated from one another. For example, a circular measuring spot marker can be formed by two semicircular sighting beams or by two circle segments that cover more or less than a semicircle. In the second case there is an interruption of the circle, with the circle still remaining easily recognizable depending on the size of the interruption. A square measuring spot marker could likewise be composed of four linear sighting beams.

It is particularly advantageous if the measuring spot marking device has N≧2 sighting beam generators. Two to four sighting beams, in particular, represent a good compromise of brightness and shape fidelity versus the assembly and calibration effort and the costs.

The measuring spot is generally circular due to the optics of the detector that image the radiation of the measurement object onto the sensor. The measuring spot marking device with N sighting beam generators is therefore preferably arranged coaxially around the radiation detector, at least around the optical axis, and generates a substantially circular measuring spot marker bounding the measuring spot.

In this case, the transmissive optical elements of the N sighting beam generators each generate a circular segment that forms essentially the Nth part of a circle. The sighting beam generators are expediently arranged in the measuring spot marking device separated equally from one another, rotated by 360°/N relative to one another. Overall, this results in a circular measuring spot marker bounding the measuring spot.

It is additionally conceivable to project a type of cross hair or a second concentric structure inside the bounding measuring spot marker, so that the center of the measuring spot is also marked. Because the transmissive optical elements allow any desired beam shapes without additional effort, however, any conceivable other measuring spot marker can be very easily realized.

It is also conceivable to match the inner circle to a switchable focal point of the sensor optics so that the inner circle simply serves as a marker in the switching of the focal point. One can thereby save the expense for a second measuring spot marking device for the second focal point, so that overall the device is more economical and easier to manufacture.

It is particularly power-saving if the individual sighting beam generators are triggered sequentially in a rapid sequence so that only one segment of the measuring spot marker is projected at any given point in time. It should be kept in mind here that the entire measuring spot marker must be presented at least 25 times so that, because of persistence of vision, the segments are not individually perceived.

A refinement of the invention that is particularly advantageous for thermal imaging cameras generating a thermographic image can provide that the imaging optics are connected to a third adjustment device with which the focusing of the imaging optics can be varied. It is advantageous in this case that not only the detail image, but also the two-dimensional resolution, can be varied.

An advantageous implementation of the invention can provide, for realizing the coupling of the variation in the imaging scale and the variation of the size of the measuring point marker on the measurement object, that the first and second adjustment devices are mechanically and/or electronically coupled, or that the first and second adjustment devices are identical or are comprised by a common adjustment device.

Particularly user-friendly operation and a weight-saving structure result if the first and second adjustment devices can be operated by means of a shared drive unit.

In order to vary the size of the measuring spot marker, it can be provided that the imaging scale of the sighting beam generator can be varied with the second adjustment device.

For varying the size of the measuring spot marker, it can be alternatively or additionally provided that the orientation of at least two sighting beam generators relative to one another can be varied with the second adjustment device.

The invention can advantageously be used in measurement devices in which the IR radiation detector comprises a field arrangement of microbolometers for recording a thermal image.

A readily visible and easily handled measuring spot marker describes a circular boundary of the measuring spot.

An advantageous implementation of the invention can provide that a display means is constructed for a measured temperature and/or recorded thermal image. The measurement device is preferably constructed as a portable handheld device that can be operated without additional display means and allows a direct monitoring of the measurement being conducted.

The invention can advantageously be used for measurement devices constructed as a single-point pyrometer, which thus allows the detection of a single temperature value during a measurement. Due to the adjustability of the imaging scale of the imaging optics, it is possible with such devices to determine an average value for the temperature in a selected section of the measurement objects with a single measurement, without having to change the position of the measurement device.

The invention will be described below in detail on the basis of embodiments, but is not limited to the embodiments. Additional embodiments arise by combination of the characteristics of the described embodiment with one another and/or with characteristics of the other embodiments.

Therein:

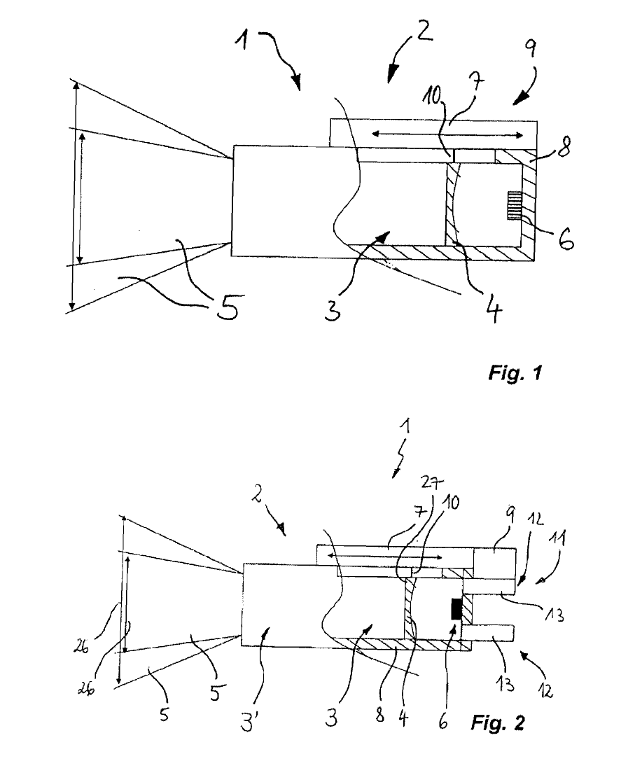

FIG. 1 shows a schematic representation of a measurement device according to the invention,

FIG. 2 shows a schematic representation of an additional measurement device according to the invention,

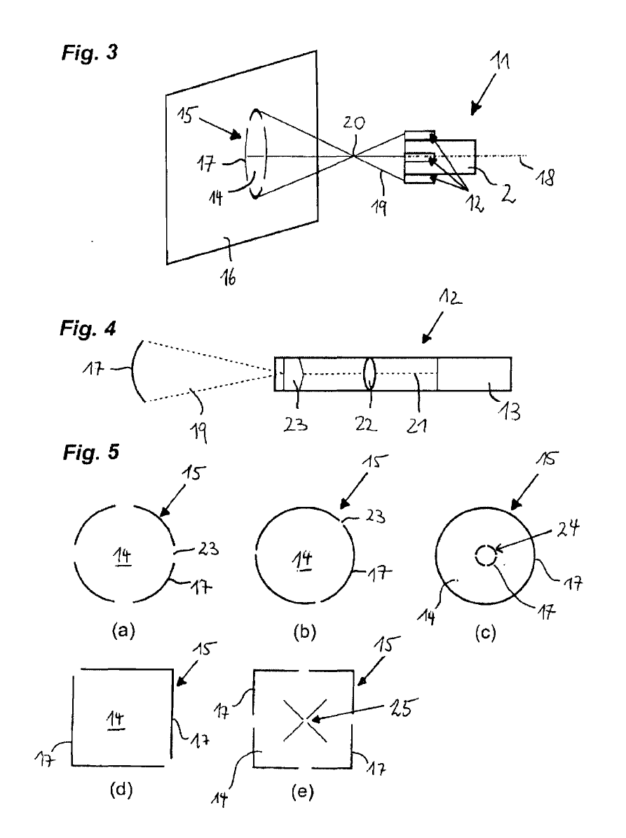

FIG. 3 shows a schematic representation of a measuring spot marking device with sighting beams indicated,

FIG. 4 shows a schematic cross-sectional representation of a sighting beam generator, and

FIG. 5 shows representations of various configurations of the measuring spot marker.

A portable temperature measurement device labeled 1 as a whole, having an infrared radiation detector 2 for measuring the temperature of the measuring spot on a measurement object, not shown, is represented in the partially cutaway plan view of FIG. 1. Detector 2 is provided with an optical arrangement 3 with optical elements 4, the example in FIG. 1 showing only one lens as an optical element 4 for the sake of clarity. A radiation signal emitted by a measurement object, not shown, is guided along different beam paths 5 onto a sensor element 6 of detector 2, depending on the adjustment of the optical elements 4 of optical arrangement 3. The planar extent of the beam paths is indicated here by the double arrows. It is easily recognizable in FIG. 1 that optical arrangement 3 of temperature measurement device 1 is furnished with an adjustment device 7, with which the optical elements 4 can be positioned to vary the image distance of optical arrangement 3. In the positioning brought about by adjustment device 7, one or more of the optical elements 4 carry out a linear motion indicated by the double arrow on adjustment device 7, and are positioned thereby, either relative to one another or, in groups or as a whole, relative to sensor element 6.

The optical element 4 constructed as a lens in FIG. 1 is movable inside housing 8 with respect to the other optical elements, not shown. It is likewise not recognizable in FIG. 1 that an additional optical element is arranged as a diaphragm, at the left from the perspective of the observer, in the entry area of temperature measurement 1. On the other hand, it is easily recognizable that adjustment device 7 is arranged parallel to the optical arrangement 3 of temperature measurement device 1 that it is to move. Adjustment device 7 is provided here with a drive means 9 in the form of an electric stepper motor that drives the movement of optical elements 4. In order to transform the rotational movement provided by drive means 9 into a linear movement of optical elements 4, a coupling means 10 is provided between drive means 9 and optical elements 4 and engages with the latter.

The temperature measurement device is further provided with a projection means, also not recognizable in the representation of FIG. 1, that projects the measurement space to be detected on the management object onto the latter. The projection is done with the aid of a laser sight as a projection means, the beam path of which depends, controllably by means of a control means not shown, on the position or adjustment of optical elements 4. In its spatial extent, the projection here corresponds essentially to the associated beam 5 formed by optical arrangement 3.

Accordingly, the above-described invention relates to a temperature measurement device 1 with a radiation detector 2 for measuring the temperature of a measuring spot on a measurement object, which detector 2 has an optical arrangement 3 with optical elements 4 that directs a radiation signal emitted by the measurement object onto a sensor element 6 of detector 2. In order to provide a portable temperature measurement device 1 that allows the user to vary the measuring spot size under difficult ambient conditions without changing the position of the temperature measurement device 1, and thus enables an easy and quickly performed temperature measurement, optical arrangement 3 is provided with an adjustment device 7 and, by means of this adjustment device 7, at least one of the optical elements 4 of optical arrangement 3 and/or sensor element 6 can be positioned to vary the image distance of optical arrangement 3 and/or modify the aperture ratio of at least one optical element 4.

FIG. 2 shows a partially cutaway schematic representation of an additional embodiment of the measurement device 1 for contactless temperature measurement according to the invention.

Measurement device 1 has a radiation detector 2 comprising imaging optics 3 for IR radiation. Imaging optics 3 comprise at least one optical element 4, with which the IR radiation 5 incident onto measurement device 1 from a measuring spot 14, described in detail in FIG. 3, on a measurement object 16 is captured and guided onto a sensor element 6 of IR radiation detector 2.

The at least one optical element 4 is constructed as a lens or mirror and is manufactured at least in a partial area from a material suited for guiding IR radiation, in particular germanium, silicon or similar materials.

Radiation detector 2 further comprises a measuring spot marking device 11 having two sighting beam generators 12, shown and described in FIGS. 3 and 4, that are arranged concentrically relative to the optical axis of radiation detector 2. These generators each have a radiation source 13 for visible light, with which the measuring spot marking device 11 produces a measuring spot marker bounding the measuring spot on the measurement object.

In the optical path of the visible light from radiation source 13 and in the beam path of IR radiation 5, IR radiation detector 2 comprises additional imaging optics 3′, not shown, that consist of an arrangement of lenses and/or mirrors.

To vary the angle of aperture for the incident IR radiation 5 and thus the size of the measuring spot on the measurement object, imaging optics 3 and imaging optics 3′ are connected to a first adjustment device 7. A variation of the angle of aperture is achieved here by virtue of the fact that the imaging scale of imaging optics 3 or the imaging scale of imaging optics 3′ can be varied with adjustment device 7.

Adjustment device 7 provides not only one movement path in this case, but several movement paths adapted to the lens system of imaging optics 3 or 3′, with transmission ratios adapted to imaging optics 3.

Adjustment device 7 is driven via a drive means 9 that is constructed in the present embodiment electrically, but can alternatively or additionally be operated mechanically, pneumatically, by a motor or some other manner.

To vary the size of the measuring spot marker on the measurement object, i.e., the angle of aperture for the incident IR rays 5, an additional adjustment device is provided, which is comprised in the present embodiment by adjustment device 7.

This additional adjustment device is coupled with first adjustment device 7 in such a manner that a variation by first adjustment device 7 of the imaging scale for the incident IR radiation 5 brings about a corresponding variation of the size of measuring spot marker 15, and thus of the angle of aperture for incident IR radiation 5, by the second adjustment device. The variability of the angle of aperture for incident IR radiation 5 is indicated in FIG. 2 by arrows 26 and the representation of different beam paths 5. The arrows 26 simultaneously mark the respective angles of aperture for incident IR radiation 5.

The measurement device 1 shown in FIG. 2 is constructed as a single-point pyrometer, in which sensor element 6 therefore consists of a single measuring cell sensitive to IR radiation. By varying the angle of aperture for incident IR radiation 5, an average temperature in the area of a measuring spot on the measurement object is accordingly detectable.

In another embodiment, sensor element 6 is constructed as a field arrangement of microbolometers for recording a thermal image, and imaging optics 3 or 3′ has a third adjustment device, with which the focusing of imaging optics 3 or 3′ can be varied.

In the embodiment according to FIG. 2, optical element 4 is optically active for visible light in its radial peripheral region 27 and is therefore suitable for guiding the beams emitted by sighting beam generators 12. Thus, a primitive adjustment device, with which the size of the measuring spot marker on the measurement object can be varied, is provided with optical element 4, particularly its radial peripheral region 27.

Optical element 4 is coupled via a coupling means 10 to first adjustment device 7 in such a manner that a variation of the imaging scale of imaging optics 3 or 3′, which is set by adjustment device 7, brings about a corresponding variation of the size of the measuring spot marker by optical element 4, in particular its radial peripheral area 27. The radial peripheral area 27 constructed for varying the size of the measuring spot marker is coupled mechanically to adjustment device 7 in the present embodiment.

Optical element 4, as well the other fixed or movable components of imaging optics 3 or 3′, is arranged in a housing 8 and guided therein.

In another embodiment, drive means 9 from FIG. 2 engages with measuring spot marking device 11, and in particular with sighting beam generators 12, whereby the relative orientation of the sighting beam generators 12 with respect to one another, and consequently the size and/or shape of the measuring spot marker produced by them, can be varied.

FIG. 3 shows a measuring spot marking device 11 as part of a portable temperature measurement device 1 (not shown) according to FIG. 1 or FIG. 2.

Four sighting beam generators 12, whose sighting beams 19 intersect at focal point 20 of the sensor optics so that the image corresponds to measuring spot 14, are arranged coaxially about optical axis 18 of radiation detector 2. The circular measuring spot marker 15, composed in the example shown of four circular segments 17, precisely bounds measuring spot 14 on measurement object 16. Thus a targeted and precise measurement is possible, without also inadvertently measuring undesired objects.

The sighting beam generator 12 shown in FIG. 4 has a laser beam source 13 at one end. Laser beam 21 is guided by a lens 22 in order to strike, at the other end of sighting beam generator 12, a transmissive optical element 23 in which laser beam 21 is shaped and exits sighting beam generator 12 as a quarter-circle segment 17 in the example shown.

Lens 22 is a component of an additional adjustment device, not shown in detail, that is coupled to adjustment device 7 from FIG. 1 or FIG. 2 to adapt the size of measuring spot marker 15 to the size of measuring spot 14.

FIG. 5 shows several possible embodiments of a measuring spot marker 15 according to the invention. The circular measuring spot marker 15 in FIG. 5(a) is composed of four circular segments 17 that do not contact one another. The resulting gaps 23 are not disruptive in the overall perception of the circle, however. Because of the four segments, it appears obvious to create this measuring spot marker 15 with four sighting beam generators 12. Because of the possibility of representing any desired shape with beam shaper 23, it is equally possible however, to create this measuring spot marker 15 with one, two or an arbitrary number of sighting beam generators 12.

The measuring spot marker 15 shown in FIG. 5(b) consists of three segments 17 which almost contact one another. Circular measuring spot 14 is thereby almost completely bounded. Gaps 23 are therefore nearly invisible. In principle, this measuring spot marker 15 can also be created from an arbitrary number of sighting beam generators 12.

In the measuring spot marker 15 shown in FIG. 5(c), a second concentric marker 24 is arranged in the vicinity of the center of measuring spot marker 15 or thereon to mark the center of measuring spot 14. A projection by two sighting beam generators 12, one for the inner and one for the outer circle, would also be conceivable. It is expedient, however, to use four sighting beam generators 12, each producing a circular segment 17 with an inner and an outer line, the outer segments overlapping so that a closed circle results.

FIG. 5(d) shows a square measuring spot marker 15 that appears to be composed of two segments 17. The square measuring spot marker 15 shown in FIG. 5(e) has, in addition to the border, a central cross hair 25 for marking the center of measuring spot 14.

This representation of measuring spot markers for the sake of example is only a selection of the many possibilities, and serves only for explanation. The invention is by no means limited thereto.

Measurement device 1 for contactless temperature measurement provides imaging optics 3, 3′ for incident IR radiation 5 from a measuring spot 14 on the measurement object 16, and a measuring spot marking device 11 that generates a measuring spot marker 15 bounding measuring spot 14, wherein the angle of aperture captured by imaging optics 3, 3′ can be varied with an adjustment device 7, and a variation of the size of measuring spot marker 15 corresponding to the variation of angle of the aperture can be produced with adjustment device 7.

1. Measurement device for contactless temperature measurement, in particular, a portable measurement device, with an IR radiation detector (2) and imaging optics (3, 3′) for IR radiation, wherein imaging optics (3, 3′) capture the IR radiation (5) incident onto measurement device (1) from a measuring spot (14) on a measurement object (16) and guide it onto a sensor element (6) of IR radiation detector (2), and with a measuring spot marking device (11) with at least one measuring spot marking device generator (12) having a beam source (13) for visible light and least one optical element (4, 22, 23), wherein measuring spot marking device (11) produces a measuring spot marker (15) bounding measuring spot (14) on measurement object (16), characterized in that a first adjustment device (7) with which the imaging scale of imaging optics (3, 3′) can be varied is connected to imaging optics (3, 3′), in that a second adjustment device (7, 9, 27) is provided, with which the size of measuring spot marker (15) on measurement object (16) can be varied, and in that first adjustment device (7) is coupled (10) to second adjustment device (7, 9, 27) in such a manner that a variation of the imaging scale by first adjustment device (7) brings about a corresponding variation of the size of measuring spot marker (15) by second adjustment device (7, 9, 27).

2. Measurement device according to claim 1, characterized in that imaging optics (3, 3′) are connected to a third adjustment device with which the focusing of imaging optics (3, 3′) can be varied.

3. Measurement device according to claim 1, characterized in that first adjustment device (7) and second adjustment device (7, 9, 27) are coupled (10) mechanically and/or electronically.

4. Measurement device according to claim 1, characterized in that first adjustment device (7) and second adjustment device (7, 9) are operable by means of a common drive unit (9) and/or in that first adjustment device (7) and second adjustment device (7, 9, 27) are identical.

5. Measurement device according to claim 1, characterized in that the imaging scale of sighting beam generator (12) is variable by second adjustment device (7, 9, 27).

6. Measurement device according to claim 1, characterized in that the orientation of at least two sighting beam generators (12) relative to one another is variable by second adjustment device (7).

7. Measurement device according to claim 1, characterized in that IR radiation detector (2) comprises a field arrangement of microbolometers (6) for recording a thermal image.

8. Measurement device according to claim 1, characterized in that measuring spot marker (15) describes a circular bound (17) of measuring spot (14).

9. Measurement device according to claim 1, characterized in that a display means for a measured temperature and/or recorded thermal image is constructed.

10. Measurement device according to claim 1, characterized in that measurement device (1) is single-point pyrometer.

11. Measurement device according to claim 1, characterized in that imaging optics (3, 3′) are formed by a number of lenses and/or mirrors that are movable relative to one another inside a housing (8).

12. Measurement device according to claim 1, characterized in that one of the optical elements of imaging optics (3, 3′) is provided as a diaphragm with an aperture diameter that is discretely or continuously variable by first adjustment device (7).

13. Measurement device according to claim 1, characterized in that first adjustment device (7) is furnished with at least one drive means (9) that is drivable manually, electrically, pneumatically or hydraulically.

14. Measurement device according to claim 1, characterized in that sighting beam generator (12) has a beam shaper (23) having at least one transmissive optical element.

15. Measurement device according to claim 1, characterized in that infrared radiation detector (2) has a circular measuring spot (14) and measuring spot marking device (11) is arranged coaxially around infrared radiation detector (2) and/or produces a substantially circular measuring spot (15) bounding measuring spot (14).
